(19) United States
(12) Patent Application Publication
(10) Pub. No.: US 2019/0031982 A1
(43) Pub. Date: Jan. 31, 2019

(54) WATER-SOLUBLE PACKAGE

(71) Applicant: Conopco, Inc. d/b/a UNILEVER, Englewood Cliffs, NJ (US)

(72) Inventors: Daniël Albert van DOORN, Dordrecht (NL); Matthew Rhys THOMAS, New Ferry, Wirral (GB)

(73) Assignee: Conopco, Inc. d/b/a UNILEVER, Englewood Cliffs, NJ (US)

(21) Appl. No.: 16/072,299

(22) PCT Filed: Jan. 18, 2017
(86) PCT No.: PCT/EP2017/051004

§ 371 Date: Jul. 24, 2018

(30) Foreign Application Priority Data
Feb. 9, 2016 (EP) 16154887.0

(51) Int. Cl. C11D 17/04; B65D 65/46

(52) U.S. Cl. CPC C11D 17/042; B65D 2203/02; B65D 65/46

(57) ABSTRACT

The present invention relates to a printed water-soluble package comprising bittering agent and a water-soluble substrate enclosing a composition, an exterior surface of the water-soluble substrate having one or more printed regions including a UV-cured ink, methods of producing such packages and their use, particularly, in detergent compositions packaging, washing dishes and laundering textiles.

The present invention relates to a printed water-soluble package including a bittering agent, in particular, packages containing dish-washing or laundry detergent compositions, methods of producing such packages and their use in dish washing or textile laundering.

Water-soluble packages known in the art typically include a composition, such as a dish-washing or laundry detergent composition enclosed in a water-soluble film, container or capsule. The detergent composition can therefore be released from the water-soluble package on exposure to water during use. Such water-soluble packages provide the advantages of providing single dosing packages, the user does not need to open the package and the user is not exposed to the detergent composition before use.

Typically, the contents of such water-soluble packages must be released quickly and completely during use in water, and without leaving a residue. As a result, the water-soluble package is often a thin water-soluble film package or a thin walled water-soluble capsule or container, and may have a high water solubility or reactivity.

Furthermore, it is often desirable to deter humans or animals from orally ingesting the contents of water-soluble packages. Accordingly, it is known to include a bittering agent in a water-soluble package in order to produce a bitter taste in the mouth if, for example, a child attempts to eat the film package. EP 0 700 989 A1 describes a unit packaged detergent for dish washing which may include an additive which provides an unbearable bitter taste, such as denatonium (e.g. bitrex™). The additive may be coated onto the unit package detergent in order to improve the prevention that children may accidently ingest the package detergent.

WO 2008/034594 A1 and EP 2 196 531 A1 describe coated detergent compositions, including a water-soluble coating. Both documents note that the unit coated detergent can include a coating of an unbearable bitter tasting additive, either as part of the water-soluble coating or as a separate layer.

More recently, WO 2014/026856 A1 identifies that when the bittering agent is included in a water-soluble film at higher doses, the bittering agent can be transferred to a user's hands when handling the water-soluble film, thus leaving bitterness on the user's hands for several hours. Accordingly, WO 2014/026856 A1 describes a water-soluble package containing an agent and a water-soluble covering wherein the water-soluble covering contains a bittering agent in a diluted state in order to solve this problem.

Furthermore, water-soluble packages often include printed information, such as text and/or pictures visible on an exterior surface of the package, in order to show the nature of the contents, to provide any instructions and/or warn of any potentially hazardous materials, for example. Typically, a water-soluble film material is printed with one or more dye or pigment layers on to the material using an ink, before adding a protective or lacquer layer on top of the ink or pigment layers. In some instances, the water-soluble film material is printed with a primer layer first, then printed with the ink. The printed water-soluble material may then be used to form a printed water-soluble package enclosing a composition or material, such as a detergent composition.

### SUMMARY OF THE INVENTION

The present inventors wish to include a bittering agent into a printed water-soluble package. Accordingly, the present inventors have investigated ways of improving printed water-soluble packages. However, they have discovered that containing a bitter agent within or film-coated on a water-soluble substrate has adverse effects on the appearance of certain printed matter on an exterior surface of the water-soluble substrate.

The present inventors have thus sought to provide a printed water-soluble package including a bittering agent with improved printed information retention over time. At its most general, the present invention provides a printed water-soluble package comprising a bittering agent, a water-soluble substrate enclosing a composition, and a UV-cured ink on an exterior surface of the water-soluble substrate. Unlike other ink systems, the bittering agent may not adversely affect the UV-cured ink printed matter.

In a first aspect, the present invention provides a printed water-soluble package comprising a bittering agent and a water-soluble substrate enclosing a composition, wherein the water-soluble substrate has an exterior surface with one or more printed regions, wherein the printed region or regions include a UV-cured ink, and the bittering agent is incorporated within or film-coated on the exterior surface of the water-soluble substrate in the or at least one printed region.

In a second aspect, the present invention provides a water-soluble enclosure, the water-soluble enclosure comprising a printed water-soluble substrate arranged to form a cavity to receive a composition or material to be enclosed by the substrate, wherein the water-soluble substrate has an exterior surface with one or more printed regions, and wherein the printed region or regions include a UV-cured ink and the bittering agent is incorporated within or film-coated on the exterior surface of the water-soluble substrate in the or at least one printed region. Such an enclosure may be filled with a composition or material to produce a water-soluble package of the first aspect.

In a third aspect, the present invention provides a printed water-soluble substrate including a bittering agent, wherein the water-soluble substrate has an exterior surface with one or more printed regions, and wherein the printed region or regions include a UV-cured ink and the bittering agent is incorporated within or film-coated on the exterior surface of the water-soluble substrate in the or at least one printed region. The substrate may be used to make a water-soluble package of the first aspect or a water-soluble enclosure of the second aspect.

In a fourth aspect, the present invention provides a method of producing a printed water-soluble package according to the first aspect, the method including a step of UV-curing a UV-curable ink in a printed region on an exterior surface of a water-soluble substrate having a bittering agent within or film-coated on the exterior surface of the water-soluble substrate in the or at least one printed region.

In a fifth aspect, the present invention provides use of a printed water-soluble package according to the first aspect for washing dishes or laundering textiles, wherein the composition or material enclosed in the substrate is a dish washing detergent compositions or a laundry detergent composition.

Water-Soluble Package “Water-soluble package” means any package construction that is suitable for enclosing and containing the composition, such as a dish-washing or laundry detergent composition. The water-soluble package can be in any packaging form, such as film packaging, capsules, and containers. In particular embodiments, the water-soluble package is a single dose water-soluble package.

The water-soluble package typically contains at least one compartment for containing the composition. In some embodiments, the water-soluble package includes two or more compartments. Each compartment can contain a different composition from another compartment. Alternatively, each compartment may contain a different component (or mixture of components) of a composition from another compartment. For example, the water-soluble package may contain two compartments wherein each compartment is a different mixture of components of a laundry or dish-washing composition.

When the water-soluble package includes two or more compartments for containing compositions and/or composition component(s), a printed region may be on an exterior surface of one or more of the compartments. In some embodiments, the water-soluble has two or more compartments, the exterior surface of at least one compartment includes a printed region and the exterior surface of at least one other compartment includes an unprinted region.

### Water-Soluble Substrate

The water-soluble substrate typically forms a wall or walls of the water-soluble package for enclosing a composition. The exterior surface of the substrate is a surface that is intended to be exposed to the environment during use. The exterior surface typically opposes an interior surface intended to face or abut the composition to be contained, encased or enclosed in the water-soluble package (such as a dish-washing or laundry detergent composition).

Suitable water-soluble substrate materials are known. In particular, the water-soluble substrate may include one or more water-soluble polymers. In one embodiment, the water-soluble substrate includes polyvinyl alcohol, a modified polyvinyl alcohol, polyvinyl acetate, polyacrylates, water-soluble acrylate copolymers, polyaminopropyl sulfonic acid and salts thereof, polyitaconic acid and salts thereof, polyacrylamides, polyvinylpyrrolidone, pullalan, cellulosics (such as carboxymethylcellulose and hydroxypropyl methyl cellulose), water-soluble natural polymers (such as guar gum, xanthan gum, carrageenan and starch), water-soluble polymer derivatives (such as modified starches, including ethoxylated starch and hydroxylated propylstarch, poly(sodium acryloamido-2-methylpropane sulfonate, polymonomethylmaleate and salts thereof), copolymers thereof and combinations thereof. In some embodiments, the water-soluble substrate includes, or consists essentially of, polyvinyl alcohol, a modified polyvinyl alcohol, polyvinyl acetate, carboxymethylcellulose or hydroxypropyl methyl cellulose.

In particular embodiments, the water-soluble substrate includes, or consists essentially of, polyvinyl alcohol, polyvinyl acetate and/or a modified polyvinyl alcohol. Polyvinyl alcohol, polyvinyl acetate and modified polyvinyl alcohols can provide stable water-soluble substrates that have suitable dissolution rates.

The water-soluble substrate material may also contain one or more plasticizers. Examples of plasticizers include, but are not limited to glycerol, glycerin, diglycerin, ethylene glycol, diethylene glycol, triethylene glycol, tetraethylene glycol, monopropylene glycol, polyethylene glycol, neopentyl glycol, trimethylpropane polyether polyols, sorbitol, ethanolamines and mixtures thereof. The plasticizer, when present, may be included in the water-soluble substrate material in an appropriate amount, as generally known.

The water-soluble package substrate encloses or contains a composition or material. In use, the water-soluble substrate may dissolve in water to release the material or composition enclosed within the substrate. Such materials and compositions particularly include, but are not limited to, detergent compositions, such as dish-washing compositions and laundry detergent compositions. The material or composition may be in solid, granular, gel or liquid form.

### Printed and Unprinted Regions

As described herein, the printed region or regions has one or more layers of a UV-cured ink deposited on the exterior surface of the water-soluble substrate. The layer or layers of UV-cured ink may be deposited directly or indirectly on the exterior surface of the water-soluble substrate. For example, the printed region may include one or more primer layers between the layer of UV-cured ink and the exterior surface of the substrate. Alternatively or additionally, the printed region may include a protective or lacquer layer on top of the layer or layers of UV-cured ink.

In most embodiments, the printed water-soluble package will include a UV-cured ink as the sole ink, pigment or dye of the printed water-soluble package. Similarly, the printed water-soluble enclosure may include a UV-cured ink as the sole ink, pigment or dye of the printed water-soluble enclosure. The printed water-soluble substrate may include a UV-cured ink as the sole ink, pigment or dye of the printed water-soluble substrate.

The water-soluble substrate surface may also have one or more unprinted regions. The unprinted region or regions of the water-soluble substrate have an exterior surface substantially free of deposited UV-cured ink (or other dye or pigment).

### UV-Curable Ink and UV-Cured Ink

The present invention includes a water-soluble package with an UV-cured ink on an exterior surface of the water-soluble substrate. Application (e.g. printing) of a UV-curable ink onto a substrate and curing the UV-curable ink to form a UV-cured ink are known per se. UV-curable inks and UV-curing equipment for curing UV-curable inks are commercially available.

UV-curable ink typically includes one or more pigments or dyes, fluid oligomers and/or monomers, and a photoinitiator. The UV-curable ink may include one or more additives and/or a solvent. Typically, the oligomers impart the basic performance properties of the cured ink, including its adhesion range and flexibility; the monomers may have the function of providing lower ink or coating viscosity; the pigments give the correct colour; photoinitiators ensure UV-curing is achieved; and optional additives fine-tune ink performance, e.g. defoamers, wetting agents, fillers, flatting agents, slip aids and dispersants.

The UV-curing of the UV-curable ink leads to reaction of the oligomers and/or monomers in the ink to form the UV-cured ink. UV-curing typically is achieved through free-radical or cationic reaction.

Free-radical reaction typically involves polymerisation of the oligomers and/or monomers by a free radical (generated when the photoinitiator absorbs UV light). In particular, the polymerisation may involve double bonds in the oligomers and/or monomers. (Meth)acrylate oligomers and/or monomers may be used in the UV-curable ink.

Cationic reaction typically involves polymerisation of the oligomers and/or monomers by a Lewis acid (generated when the photoinitiator absorbs UV light). In particular, the polymerisation may involve epoxy groups in the oligomers and/or monomers. Cycloaliphatic epoxy (such as 3,4-epoxycyclohexylmethyl-3,4-epoxycyclohexane carboxylate) oligomers and/or monomers may be used in the UV-curable ink.

Examples of suitable oligomers of the UV-curable ink include, but are not limited to, (meth)acrylated epoxies (such as bisphenol A diglycidyl ether diacrylate), (meth)acrylated aliphatic urethanes, (meth)acrylated aromatic urethanes, (meth)acrylated polyesters and (meth)acrylated acrylics. Examples of suitable monomers of the UV-curable ink include, but are not limited to, isobornyl acrylate (IBOA), tripropylene glycol diacrylate (TRPGDA), and trimethylol propane triacrylate (TMPTA). Other examples of oligomers and monomers for use in a UV-curable ink are known in the art, and may be used in the present invention.

Photoinitiators for use in UV-curable inks are known. Examples of suitable photoinitiators include, but are not limited to, Type I initiators (such as 1-hydroxy-cyclohexylphenly-ketone) and Type II initiators (such as benzophenone).

UV-curing equipment may include a mercury vapour lamp. Such lamps can create radiation with wavelengths that will be effective for ink curing. UV radiation with wavelengths of 365-366 nanometres provides a suitable for curing UV-curable inks. In some embodiments, the UV-curable ink is an LED-curable ink. The LED-curable ink may be cured using an LED light.

The UV-cured ink is typically a solid formed by UV-curing a UV-curing ink. The UV-cured ink typically includes the pigment or dye within a solid polymer including units of the UV-curable ink oligomer and monomer. The UV-cured ink may also include the photoinitiator and/or one or more additives of the UV-curable ink. The UV-cured ink may include a cured polymer with (meth)acrylate units, a cured polymer with cycloaliphatic ether units or a cured polymer with (meth)acrylate units and cycloaliphatic ether units.

### Bittering Agent

The water-soluble package of the present invention includes a bittering agent. Bittering agents are generally known. In some embodiments, the bittering agent is selected from benzoic benzylamine amide, denatonium benzoate, denatonium saccharide, trichloroanisole, methyl anthranilate and quinine (and salts of quinine). Further examples of bittering agents include naringin, sucrose octaacetate and agents derived from plant or vegetable matter, such as chemical compounds derived from chilli pepper plants, those derived from a plant species of the genus cynaro, alkaloids and amino acids.

In some embodiments, the bittering agent is selected from the group consisting of denatonium benzoate, denatonium saccharide, quinine or a salt of quinine. The chemical name of denatonium is phenylmethyl-[2-[(2,6-dimethylphenyl)amino]-2-oxoethyl]-diethylammonium. In particular embodiments, the bittering agent is denatonium benzoate or denatonium saccharide.

The bittering agent is typically incorporated within or film-coated on the exterior surface of the water-soluble package. Additionally or alternatively, the bitter agent is included in the water-soluble package as a powdered bittering agent in a powder coating applied to the exterior surface of the water-soluble package.

In particular embodiments, the bittering agent is incorporated within (included in) the water-soluble substrate. For example, the bittering agent may be incorporated into the matrix of a water-soluble polymer included in the water-soluble substrate by dissolving the bittering agent in a water-soluble polymer solution before the water-soluble substrate is formed. The bittering agent may be present in water-soluble substrate material in a range of 100 to 5000 ppm, preferably 200 to 3000 ppm, more preferably 500 to 2000 ppm, based on the weights of the bittering agent and water-soluble substrate. For example, 1 mg of bittering agent may be incorporated into 1 g of water-soluble substrate to provide the bittering agent at 1000 ppm.

Film-coating of a bittering agent on the surface of the water-soluble substrate can be performed by known techniques, such as spraying or printing of a bittering agent solution onto the surface of the water-soluble substrate.

The bittering agent can be included in, film coated on and/or included in a powder coating on the exterior surface of the water-soluble substrate in one or more of the printed regions. There may be no adverse effects on the quality of UV-cured ink printed matter when the bittering agent is included in, film coated on and/or included in a powder coating on the exterior surface of the water-soluble substrate in the printed regions. In particular, there may be no adverse effects on the quality of UV-cured ink printed matter when the bittering agent is incorporated within the water-soluble substrate in the printed regions. In some embodiments, the bittering agent is incorporated within the water-soluble substrate homogenously. In this way, the inclusion of the bittering agent into the water-soluble substrate and printing of the water-soluble substrate can be simplified.

### Powder Coating

The printed water-soluble package can include a powder coating on an exterior surface of the water-soluble substrate. The powder coating can include a powdered bittering agent. Alternatively or additionally, the powder coating can include a powdered lubricating agent. The powder coating, when present, may coat the printed region or regions and/or the unprinted region or regions (if present) of the water-soluble substrate. In the printed regions of the water-soluble substrate, the powder coating may be indirectly on the exterior surface of the water-soluble substrate where there is a layer of UV-cured ink.

The powder coating, when present, typically is applied to at least 50% by area of the exterior surface of the water-soluble substrate. In some embodiments, the powder coating is applied to 60% or more, 70% or more, 80% or more, or 90% or more by area of the exterior surface of the water-soluble substrate. The powder coating can be applied by any known technique such as spray coating or passing the water-soluble substrate through a falling curtain of powder coating composition.

The powder coating, when present, may be applied to the exterior surface of the water-soluble substrate at a rate of 0.5 to 10 mg per 100 cm², in some embodiments not more than 5 mg per 100 cm², and in further embodiments in the range of 1.25 to 2.5 mg per 100 cm². Alternatively, the powder coating is applied to or present on the exterior surface of the water-soluble substrate in an amount of 100 ppm or more, preferably 200 ppm or more, more preferably 300 ppm or more, based on the weights of the powder coating and the water-soluble substrate. For example, a 1 mg of powder coating may be applied to a 1 g water-soluble substrate to provide a 1000 ppm coating on the substrate. In certain embodiments, the powder coating is applied to or present on the exterior surface of the water-soluble substrate in a range of 100 to 5000 ppm, preferably 200 to 3000 ppm, more preferably 300 to 2000 ppm.

The powder coating, when present, can include 10 wt. % or more of a powdered lubricating agent based on the total weight of the powder coating. Typical powdered lubricating agents include oligosaccharide, polysaccharide and inorganic lubricating agents. The powdered coating may include one or more of the group selected from starch, modified starches (including, but limited to, corn starch, potato starch or hydroxyethyl starch) silicas, siloxanes, calcium carbonate, magnesium carbonate, clay, talc, silicic acid, kaolin, gypsum, zeolites, cyclodextrins, calcium stearate, zinc stearate, alumina, magnesium stearate, sodium sulphate, sodium citrate, sodium tripolyphosphate, potassium sulphate, potassium citrate, potassium tripolyphosphate and zinc oxide. In a preferred embodiment, the powdered lubricating agent includes talc.

In some embodiments, the powdered lubricating agent forms 25 wt. % or more, 30 wt. % or more, 35 wt. % or more, 40 wt. % or more, or 45 wt. % or more of powder coating based on the total weight of the powder coating. In some embodiments, the powdered lubricating agent forms 95 wt. % or less, 90 wt. % or less, 85 wt. % or less, 80 wt. % or less, or 75 wt. % or less of the powder coating based on the total weight of the powder coating. In certain embodiments, the powdered lubricating agent forms in the range of 25 to 95 wt. %, 30 to 90 wt. %, 35 to 85 wt. %, 40 to 80 wt. %, or 45 to 75 wt. % of the powder coating based on the total weight of the powder coating. In alternative embodiments, the powdered lubricating agent forms 50 wt. % or more, 60 wt. % or more, or 70 wt. % or more of the powder coating based on the total weight of the powder coating.

The powdered lubricating agent may have an average particle diameter of at least about 0.1 microns. The powdered lubricating agent may have an average particle diameter of about 200 microns or less. In some embodiments, the powdered lubricating agent has an average particle diameter in the range of about 0.1 to 100 microns, in other embodiments in the range of about 0.1 to 20 microns and in further embodiments in the range of about 5 and 15 microns. Average particle diameter can be measured by known optical imaging techniques.

When a bittering agent is included in a powder coating, the powdered bittering agent may be a powdered form of any one of the bittering agents described herein. In preferred embodiments, the powdered bittering agent is selected from a powdered form of denatonium benzoate, denatonium saccharide, quinine or a salt of quinine.

The powdered bittering agent may form 5 wt. % or more of the powder coating based on the total weight of the powder coating. In some embodiments, the powdered bittering agent forms 10 wt. % or more, 15 wt. % or more, 20 wt. % or more, or 25 wt. % or more of powder coating based on the total weight of the powder coating. In some embodiments, the powdered bittering agent forms 75 wt. % or less, 70 wt. % or less, 65 wt. % or less, 60 wt. % or less, or 55 wt. % or less of the powder coating based on the total weight of the powder coating. In further embodiments, the powdered bittering agent forms 5 to 75 wt. %, 10 to 70 wt. %, 15 to 65 wt. %, 20 to 60 wt. %, or 25 to 55 wt. % of the powder coating based on the total weight of the powder coating. In alternative embodiments, the powdered bittering agent forms 50 wt. % or less, 40 wt. % or less, 30 wt. % or less of the powder coating based on the total weight of the powder coating. In these embodiments, it is advantageous to include a relatively low amount of powdered bittering agent in the powder coating while maintaining a bitter taste when a user tries to ingest the water-soluble package.

The powdered bittering agent may have an average particle diameter of at least about 0.1 microns. The powdered bittering agent may have an average particle diameter of about 200 microns or less. In some embodiments, the powdered bittering agent has an average particle diameter of in the range of about 0.1 to 100 microns, in other embodiments in the range of about 0.1 to 20 microns and in further embodiments in a range of about 5 and 15 microns. Average particle diameter can be measured by known optical imaging techniques. For example, the diameter of all particles within a fixed area under a microscope (or other optical imaging device) can be measured and the mean diameter calculated. The diameter can be taken as the major dimension for irregularly shaped particles.

When the water-soluble package includes a powder coating including a powdered bittering agent, the water-soluble package may further include a bittering agent included within the water-soluble substrate.

In some embodiments, the powder coating consists essentially of a powdered bittering agent or a powdered lubricating agent.

In some embodiments, the powder coating further includes one or more additional active agents. The additional active agent may be selected from one or more of the group of enzymes, oils, odour absorbers, fragrances, bleaches, bleach components, cleaning polymers, soil release polymers, EPEI, water softeners, dyes and fabric softeners.

### Method of Making a Water-Soluble Package

The printed water-soluble packages of the present invention can be manufactured using standard known techniques. For example, a sheet of water-soluble substrate (e.g. film) may be printed with one or more layers of UV-curable ink in a pattern. The pattern may be indicia, such as words, symbols or drawings.

The water-soluble substrate may be printed with a primer layer before printing of the layer or layers of UV-curable ink. After printing with the layer or layers of UV-curable ink, the water-soluble substrate may be then be exposed to UV to cure the UV-curable ink. The water-soluble substrate may optionally be printed with a protective or lacquer layer. The lacquer layer or layers may be then dried, for example using heat and/or air flow. The resulting printed water-soluble substrate may be stored, transported or used immediately to form the printed water-soluble packages of the present invention.

When the bittering agent is contained within the water-soluble substrate, the bittering agent is typically present in the water-soluble substrate before printing. In another embodiment, the bittering agent is included on the exterior surface of water-soluble substrate as a film coating. The film coating of bittering agent onto the water-soluble substrate may be deposited before, during or after the printing of the printed regions with the UV-curable ink.

The printed water-soluble substrate is typically formed, preferably thermoformed, into a printed water-soluble substrate enclosure (e.g. a film pocket, open capsule or container). The printed water-soluble substrate enclosure may then be filled with a composition such as a dish-washing or laundry detergent composition. The printed water-soluble enclosure containing the composition or material can then be sealed, for example by sealing the edges of the enclosure or joining the enclosure with one or more additional pieces of water-soluble substrate, in order to enclose the material or composition in the printed water-soluble package.

Optionally, a powder coating may then be applied to the exterior surface of the water-soluble substrate. The powder coating may be applied to the water-soluble substrate by any known powder technique. Preferably, the powder is applied to the water-soluble substrate using no solvent or a non-aqueous solvent. Such an application reduces the risk of dissolving the water-soluble substrate. In some embodiments, the powder coating includes a powdered bittering agent.

The above optional and preferred features are equally combinable and applicable to all aspects of the invention, unless indicated otherwise.

In a particular embodiment, the present invention provides a printed water-soluble package comprising a water-soluble substrate and a bittering agent, wherein the water-soluble substrate has an exterior surface with one or more printed regions, the water-soluble package further including a powder coating on the exterior surface of the water-soluble substrate, wherein the printed region or regions include the UV-cured ink, and the bittering agent is incorporated homogenously within or film-coated on the exterior surface of the water-soluble substrate, and the bittering agent is selected from the group selected from denotanium benzoate, denatonium saccharide, quinine and a salt of quinine.

### DETAILED DESCRIPTION

The invention will be described in more detail with reference to specific embodiments and examples.

### Example 1 (Control)

A polyvinyl alcohol thin film (Solublon™, available from Aicello) was printed with a primer, non-aqueous solvent-based ink and lacquer combination. After rewinding of the film and transportation, thin film capsules were produced from the film, filled with two different commercially available laundry detergent compositions and loaded into standard laundry detergent capsule containers.

The containers were placed in storage at a range of climatic conditions: 20° C. & 65% relative humidity (RH); 28° C. & 70% RH; and 37° C. & 70% RH. Such conditions simulate west European ambient conditions and accelerated testing. The capsules were assessed visually at various time points.

After 18 weeks under simulated conditions, there was some evidence that dye had transferred to other capsules and a limited amount of fading of the colours existed. However, there was no significant discolouration of the dyes.

### Example 2 (Comparative)

A polyvinyl alcohol thin film (Solublon™, available from Aicello) impregnated with bitrex™ was printed with a primer, non-aqueous solvent-based ink and lacquer combination. After rewinding of the film and transportation, thin film capsules were produced from the film, filled with two different commercially available laundry detergent compositions and loaded into standard laundry detergent capsule containers.

The containers were placed in storage at a range of climatic conditions: 20° C. & 65% relative humidity (RH); 28° C. & 70% RH; and 37° C. & 70% RH. Such conditions simulate west European ambient conditions and accelerated testing. The capsules were assessed visually at various time points.

After 4 weeks under simulated conditions, there was some evidence that the dye had transferred to other capsules and a limited amount of fading of the colours. However, there was also evidence of significant discolouration of the dyes, in particular the red dye.

### Example 3

A polyvinyl alcohol thin film (Solublon™, available from Aicello) impregnated with bitrex™ is printed with a UV-curable ink , and the thin film is UV-cured. After rewinding of the film and transportation, thin film capsules are produced from the film, filled with two different commercially available laundry detergent compositions. The capsules are loaded into standard laundry detergent capsule containers.

The containers are placed in storage at a range of climatic conditions: 20° C. & 65% relative humidity (RH); 28° C. & 70% RH; and 37° C. & 70% RH. Such conditions simulate west European ambient conditions and accelerated testing. The capsules are assessed visually at various time points.

1. A printed water-soluble package comprising a bittering agent and a water-soluble substrate enclosing a composition, wherein the water-soluble substrate has an exterior surface with one or more printed regions, wherein the printed region or regions include a UV-cured ink, and the bittering agent is incorporated within or film-coated on the exterior surface of the water-soluble substrate in the or at least one printed region.

2. A printed water-soluble package according to claim 1 wherein the water-soluble substrate includes a bittering agent incorporated homogenously within the water-soluble substrate.

3. The printed water-soluble package according to claim 1 wherein the water-soluble substrate includes polyvinyl alcohol, a modified polyvinyl alcohol, polyvinyl acetate, carboxymethylcellulose or hydroxypropyl methyl cellulose.

4. The printed water-soluble package according to claim 1 wherein the bittering agent is denatonium benzoate or denatonium saccharide.

5. The printed water-soluble package according to claim 1, wherein the water-soluble package includes a powder coating and the powder coating includes a powdered lubricating agent.

6. The printed water-soluble package according to claim 5 wherein the powdered lubricating agent is talc.

7. The printed water-soluble package according to claim 1, wherein the composition or material enclosed by the water-soluble package is a dish-washing detergent composition or a laundry detergent composition.

8. The printed water-soluble package according to claim 1 wherein the package includes two or more compartments, at least one of the compartments being arranged to enclose the composition or material.

9. A water-soluble enclosure comprising a printed water-soluble substrate arranged to form a cavity to receive a composition or material to be enclosed by the substrate, wherein the water-soluble substrate has an exterior surface with one or more printed regions, and wherein the printed region or regions include a UV-cured ink and the bittering agent is incorporated within or film-coated on the exterior surface of the water-soluble substrate in the or at least one printed region.

10. A printed water-soluble substrate including a bittering agent, wherein the water-soluble substrate has an exterior surface with one or more printed regions, and wherein the printed region or regions include a UV-cured ink and the bittering agent is incorporated within or film-coated on the exterior surface of the water-soluble substrate in the or at least one printed region.

11. A method of producing a printed water-soluble package according to claim 1, the method including a step of UV-curing a UV-curable ink in a printed region on an exterior surface of a water-soluble substrate having a bittering agent within or film-coated on the exterior surface of the water-soluble substrate in the or at least one printed region.

12. A method for washing dishes or laundering textiles comprising the step of contacting a printed water-soluble package according to claims 1 with dishes or laundering textiles.
